(19) United States
(12) Patent Application Publication
(10) Pub. No.: US 2025/0134093 A1
(43) Pub. Date: May 1, 2025

(54) EASY LIFT TREE STAND STAKES

(71) Applicant: William Charles Mosher, Bellevue, MI (US)

(72) Inventor: William Charles Mosher, Bellevue, MI (US)

(21) Appl. No.: 18/933,966

(22) Filed: Oct. 31, 2024

Related U.S. Application Data
(60) Provisional application No. 63/595,213, filed on Nov. 1, 2023.

(51) Int. Cl. A01M 31/02; E04G 5/02

(52) U.S. Cl. CPC A01M 31/02; E04G 5/02

(57) ABSTRACT

The present invention is a stake apparatus designed to secure the legs of a tree stand into the ground, allowing the user to erect a tree stand with efficiency, safety, and accessibility. The present invention comprises a stake component connected to a pocket component. The pocket component is compatible with the legs or bottom end of a ladder stand, tripod, or quad-legged platform. The stake component is driven into the ground Once the stake component is secured in the ground, the user can lift a stand overhead and begin to erect the stand vertically. The stake and pocket components pivot while the stand is lifted.

### FIELD OF THE INVENTION

The present invention relates generally to tree stands commonly used for hunting and wildlife viewing and to devices used to help erect tree stands. Particularly, the present invention is a stake apparatus designed to secure the legs of a tree stand into the ground, allowing the user to erect a tree stand with efficiency, safety, and accessibility.

### BACKGROUND OF THE INVENTION

Commonly used while hunting and wildlife viewing, tree stands are platforms that can be attached to trees to provide users an elevated vantage point. From this vantage point, users can spot game and wildlife from farther distances. Tree stands also remove users from the field of vision of the animal they are hunting or observing. Additionally, some tree stands may include a chair or seat, providing comfort and stability to the user, especially during longer periods of use. These aspects of tree stands provide significant advantages to users while hunting or wildlife viewing. As a result, users have a strong incentive to include a tree stand as part of their equipment.

There are different styles of tree stands. A climbing stand involves multiple platform components that are secured to a tree while ascending. Each platform component is secured one at a time until the desired elevation is reached. To descend, each platform component must be released and re-secured step-by-step until returning to ground level. While climbing stands can be less weight to carry, there exists an inherent danger and difficulty in using them because climbing stands require a demanding process of step-by-step ascent and descent with the potential of falling or breaking loose.

A ladder stand is a type of tree stand that includes a ladder component at the bottom of a tree stand platform. This ladder component eliminates the need for the step-by-step process of ascent or descent that climbing stands require. Users can simply climb up or down rungs of a ladder to ascend to the tree stand platform or descend to ground level. In comparison to climbing stands, ladder stands are often safer and easier to use when secured. However, ladder stands can be heavier to carry and potentially more difficult to erect as the ladder component can make the tree stand cumbersome to carry and lift.

Another example of a platform used while hunting or wildlife viewing is a tripod stand. These stands can also exist as a quad-legged platform variation. Because these platforms can be freestanding and not require connection to a tree, they are not tree stands per se, but they are used for the same purposes as tree stands. Similar to ladder stands, tripods and quad-legged platforms often include a ladder component to allow a user to ascend and descend from the platform. They include three or more legs beneath the platform as foundation. These additional components further increase the weight of the equipment.

To erect a ladder stand, users place the legs or bottom end of the ladder component on the ground horizontally toward the tree that the users intend to secure the tree stand to. While at least one user secures the bottom end of the ladder component to the ground, another user must raise the ladder stand from the top end of the platform. To lift it vertically, the stand must be lifted overhead. Because of the size, shape, and weight of the tree stand, this process of lifting the tree stand overhead can be difficult and dangerous. If the bottom end of the ladder component is not secured safely and breaks loose, the ladder stand may fall and severely injure any person or animal nearby. Accordingly, this process may take additional time to execute safely. Safety instructions for these tree stands typically suggest more than one person should work together to erect and secure a ladder stand. For example, at least one user can secure the bottom end of the ladder component by simply standing on it and placing their body weight upon the stand to prevent it from breaking loose, while another user lifts the top end of the platform. At minimum, erecting these types of tree stands is physically demanding and time consuming to do correctly. Although instructional videos exist online to demonstrate how to erect tree stands alone, it is inherently dangerous and difficult to do so alone.

An objective of the present invention is to provide an apparatus that can greatly increase the efficiency, safety, and accessibility of tree stands. There is a current need to optimize the process of lifting and setting up a tree stand by reducing the physical demands on users and by increasing stability and safety. The present invention enables sole individuals to erect a ladder stand, tripod, or quad-legged platform quickly and safely. Because the present invention allows for less physical demand on the user, even users of smaller physique can erect those tree stands that may have been inaccessible to lift before.

### SUMMARY OF THE INVENTION

The present invention comprises a stake component connected to a pocket component. In use, two or more copies of the present invention may be used when raising a stand with more than one leg. The pocket component is compatible with the legs or bottom end of a ladder stand, tripod, or quad-legged platform. While the stand is placed horizontally on the ground at a proper distance from the desired tree which the stand will be secured to, the legs of the stand are secured into the pocket component by hitch pins, lynch pins, or safety pins. The stake component is driven into the ground while the stand is still laying horizontally on the ground. Once the stake component is secured in the ground, the user can then lift the top platform of the stand overhead and begin to erect the stand vertically. The stake and pocket components pivot while the stand is lifted. During this process, the present invention prevents the legs of the stand from breaking loose. Because the legs of the stand are secured into the ground by the present invention, only one user is required to lift the top platform. While a ladder stand is being secured to a tree, the present invention continues to provide support at the base. Once the stand is fully raised vertically, the user can release the hitch pins, lynch pins, or safety pins securing the stand to the pocket component. The present invention can then be removed from the stand and from the ground to be used to erect another stand. The present invention can also be left attached to the stand during use. To lower a stand horizontally, the same steps involving the present invention can be done in reverse. During the lowering process, the same benefits of efficiency, safety, and accessibility are afforded to the user as during the raising process.

### BRIEF DESCRIPTION OF THE DRAWINGS

FIG. 1 is a rear top left perspective view of the present invention.

FIG. 2 is a front elevational view of the present invention.

FIG. 3 is a left elevational view of the present invention.

FIG. 4 is a right elevational view of the present invention.

FIG. 5 is a diagram showing an embodiment of present invention attached to a leg of a ladder stand.

### DETAILED DESCRIPTION OF THE INVENTION

All illustrations of the drawings are for the purpose of describing selected versions of the present invention and are not intended to limit the scope of the present invention.

The present invention 100 is a stake apparatus designed to secure the legs of a tree stand into the ground, allowing the user to erect a tree stand with efficiency, safety, and accessibility. Multiple embodiments of the present invention, particularly mirrored embodiments, can be used in conjunction to erect a tree stand.

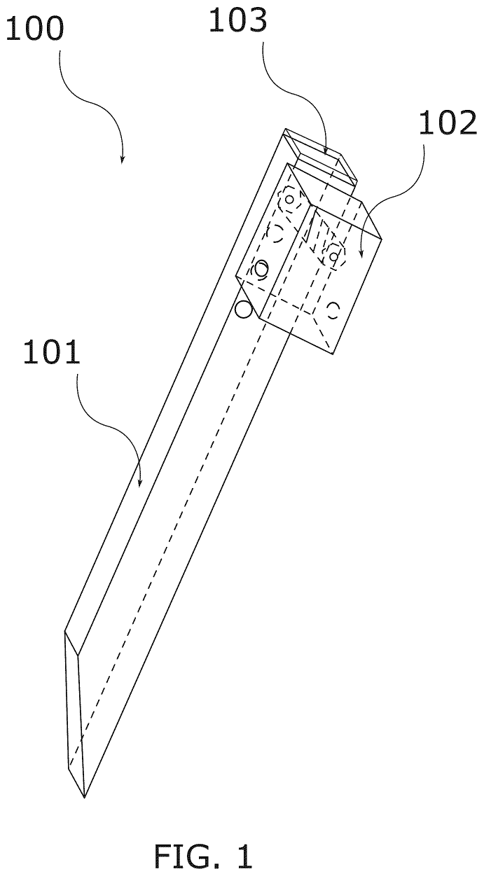

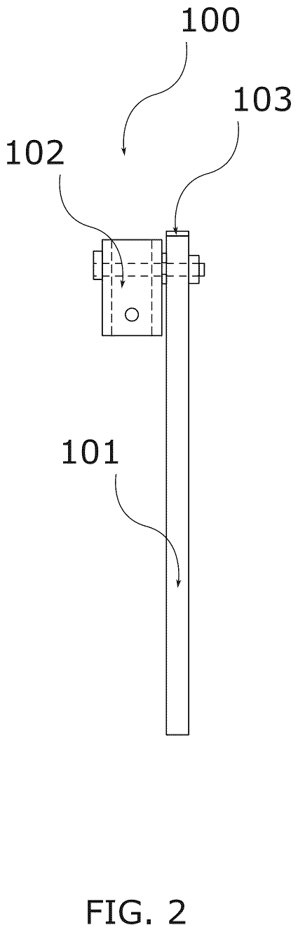

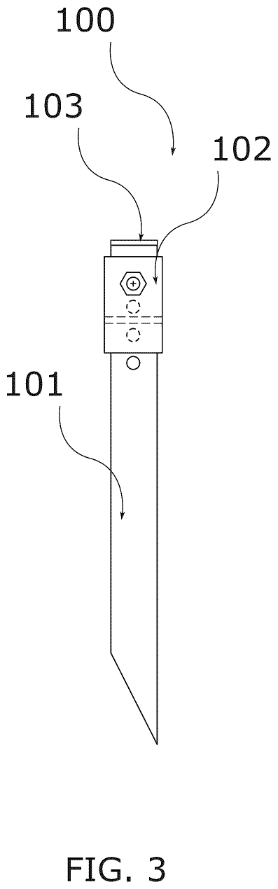

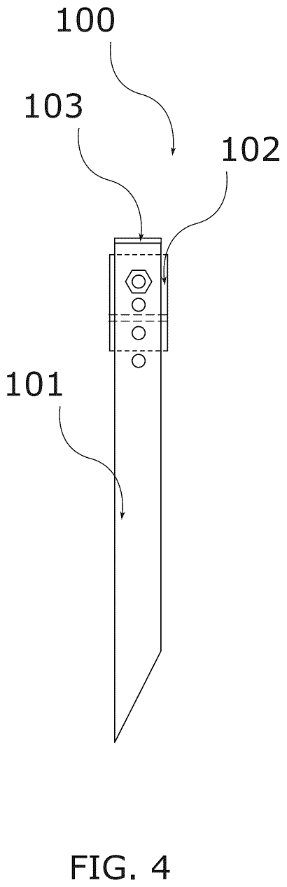

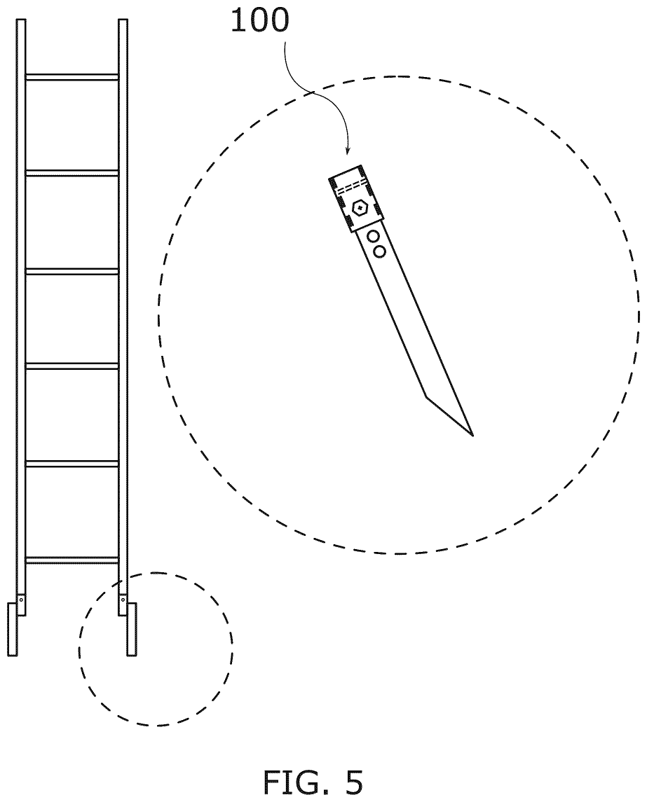

As shown in FIG. 1-5, the present invention 100 comprises two main components: a stake component 101 connected with a pocket component 102. Said stake component 101 is used to secure the present invention 100 into the ground during use of lifting a stand. In the preferred embodiment of the present invention, said stake component 101 is constructed of black iron mild tube steel. In the preferred embodiment of the present invention, the dimensions of said stake component 101 are 0.75 inches by 1.5 inches by 16 inches. The present invention 100 contemplates different embodiments comprising stake components 101 of different lengths than 16 inches, as varying terrain conditions may require a different length of stake component 101 for optimal stability. In the preferred embodiment of the present invention, the bottom of said stake component 101 tapers on a 60 degree angle. In the preferred embodiment of the present invention, the top of said stake component 101 has a through hole drilled with a 7/16 inch bit. The center of this hole is 1.25 inches from the top of said stake component 101 on the 1.5 inch side of said stake component 101. In the preferred embodiment of the present invention, three additional holes, drilled with a 7/16 inch bit, are spaced two inches apart below the initial 7.16 inch hole.

In the preferred embodiment of the present invention, said stake component 101 has a 12 gauge strike plate 103 welded to the top. Said strike plate 103 adds durability for the present invention while driving said stake component 101 into the ground.

Said pocket component 102 is compatible with the legs or bottom end of a ladder stand, tripod, or quad-legged platform. Said pocket component 102 includes an opening and cavity in which a leg of a stand may fit in to attach with the present invention. In the preferred embodiment of the present invention, hitch pins, lynch pins, or safety pins can be used to fasten said pocket component 102 with the leg of a stand. In the preferred embodiment of the present invention, said pocket component 102 is constructed of mild black iron tube steel. In the preferred embodiment of the present invention, the dimensions of said pocket component 102 are 2 inches by 2 inches by 3 inches. Said pocket component 102 has two drilled through holes. In the preferred embodiment of the present invention, the first hole is drilled with a 7/16 inch bit and located ⅞ inch from one end of said pocket component 102. In the preferred embodiment of the present invention, the second hole is drilled with a 5/16 inch bit and located ⅜ inch from the opposite end of said pocket component 102 from the first hole. Said second hole is perpendicular to said first hole and is not drilled on the same side of said pocket component as said first hole.

Said stake component 101 and said pocket component 102 are connected together. In the preferred embodiment of the present invention, said stake component 101 and said pocket component 102 are connected together by a ⅜ inch by 4 inch long grade 3 bolt using a ⅜ inch locking nut with a ⅛ inch thick nylon washer between said stake component 101 and said pocket component 102.

In the preferred embodiment of the present invention, the mild black iron tube steel material used to create each component is treated with a durable finish. The durable finish protects the steel from deterioration by moisture and other environmental elements during use.

Although the invention has been explained in relation to its preferred embodiment, it is to be understood that many other possible modifications and variations can be made without departing from the spirit and scope of the invention.

What is claimed is:

1. A stake apparatus comprising:
a stake component;
a pocket component;
a fastening mechanism; and
a securing mechanism;
wherein said stake component and said pocket component are connected through said securing mechanism;
wherein said pocket component is sized to accept a leg of a tree stand; and
wherein said pocket component can be bound to a leg of a tree stand using said fastening mechanism.

2. The stake apparatus of claim 1, further comprising:
a strike plate;
wherein said strike plate is connected to the top of said stake component;
wherein said strike plate provides additional durability to the top of said stake component.

3. The stake apparatus of claim 1:
wherein said fastening mechanism is a hitch.

4. The stake apparatus of claim 1:
wherein said fastening mechanism is a lynch pin.

5. The stake apparatus of claim 1:
wherein said fastening mechanism is a safety pin.

6. The stake apparatus of claim 1:
wherein said securing mechanism further comprises a bolt;
a washer; and
a locking nut.

7. The stake apparatus of claim 1, further comprising:
three holes through said stake component, spaced below said securing mechanism.

8. A stake apparatus comprising:
a stake component;
a pocket component;
a strike plate;
a fastening mechanism; and
a securing mechanism;
wherein said stake component and said pocket component are connected through said securing mechanism;
wherein said strike plate is connected to the top of said stake component;
wherein said strike plate provides additional durability to the top of said stake component;
wherein said pocket component is sized to accept a leg of a tree stand; and
wherein said pocket component can be bound to a leg of a tree stand using said fastening mechanism.

9. The stake apparatus of claim 8:
wherein said fastening mechanism is a hitch.

10. The stake apparatus of claim 8:
wherein said fastening mechanism is a lynch pin.

11. The stake apparatus of claim 8:
wherein said fastening mechanism is a safety pin.

12. The stake apparatus of claim 8:
wherein said securing mechanism further comprises a bolt;
a washer; and
a locking nut.

13. The stake apparatus of claim 8, further comprising:
three holes through said stake component, spaced below said securing mechanism.

14. A stake apparatus comprising:
a stake component;
a pocket component;
a strike plate;
a fastening mechanism;
a securing mechanism; and
three holes through said stake component, spaced below said securing mechanism;
wherein said stake component and said pocket component are connected through said securing mechanism;
wherein said strike plate is connected to the top of said stake component;
wherein said strike plate provides additional durability to the top of said stake component;
wherein said pocket component is sized to accept a leg of a tree stand; and
wherein said pocket component can be bound to a leg of a tree stand using said fastening mechanism.

15. The stake apparatus of claim 14:
wherein said fastening mechanism is a hitch.

16. The stake apparatus of claim 14:
wherein said fastening mechanism is a lynch pin.

17. The stake apparatus of claim 14:
wherein said fastening mechanism is a safety pin.

18. The stake apparatus of claim 14:
wherein said securing mechanism further comprises a bolt;
a washer; and
a locking nut.
